(19) United States
(12) Patent Application Publication
(10) Pub. No.: US 2021/0295684 A1
(43) Pub. Date: Sep. 23, 2021

(54) CLOUD-EDGE-END COOPERATIVE HIGHWAY CLOUD CONTROL SYSTEM AND CONTROL METHOD

(71) Applicant: RESEARCH INSTITUTE OF HIGHWAY MINISTRY OF TRANSPORT, Beijing (CN)

(72) Inventors: Yanqing CEN, Beijing (CN); Xianghui SONG, Beijing (CN); Ling SUN, Beijing (CN); Dongzhu WANG, Beijing (CN); Liwei ZHU, Beijing (CN); Dezao HOU, Beijing (CN); Liyang LU, Beijing (CN); Nan LIU, Beijing (CN); Jiahai ZHAO, Beijing (CN); Honghai LI, Beijing (CN); Yameng LI, Beijing (CN); Jian GAO, Beijing (CN); Fengman YANG, Beijing (CN)

(21) Appl. No.: 17/206,048

(22) Filed: Mar. 18, 2021

(30) Foreign Application Priority Data
Mar. 18, 2020 (CN) 202010192205.X

(51) Int. Cl. G08G 1/01; H04W 4/40

(52) U.S. Cl. CPC G08G 1/0145; G08G 1/0133; G08G 1/0116; H04W 4/40

(57) ABSTRACT

The present disclosure relates to an intelligent traffic cloud control system; by making full use of technologies such as cloud computing, edge computing, big data, and artificial intelligence, the present disclosure proposes a technical architecture of a cloud-edge-end cooperative road traffic cloud control platform, which can overcome the defects of the technical architecture of existing road traffic operation management and monitoring systems. The highway cloud control platform designed and developed based on this technical architecture can improve the operational efficiency of the road network under the premise of ensuring safety, so that highway users can obtain more timely, effective, and personalized driving and traveling assistance information; moreover, practical applications such as vehicle-road cooperative autonomous driving and other functions are supported.

### FIELD OF THE INVENTION

The present application relates to the technical field of intelligent traffic, in particular to a technical architecture of a cloud-edge-end cooperative road traffic, cloud control platform and a control method thereof.

### BACKGROUND OF THE INVENTION

It is one of the important measures of constructing a safe, convenient, efficient, green and economical modern comprehensive traffic system to build intelligent traffic, promote the deep integration of big data, Internet of Things, artificial intelligence, blockchain and other technologies with the traffic industry, realize the integrated development of traffic infrastructure network, traffic service network, and energy and information network, and improve traffic system management, operation, safety and efficiency.

As an important part of our country's traffic infrastructure and the backbone network of passenger and freight transportation, the highway has become an important field of our country's intelligent traffic construction and important scene of the application of new technologies and new industry modes, etc. Over the past years, in order to ensure the efficient management and safe operation of highways, a highway electromechanical system consisting of a monitoring system, a communication system, a toll system, a power supply and distribution system, a lighting system, and a tunnel electromechanical system has been designed in our country's highway traffic industry. Moreover, in combination with the actual road management, a hierarchical management structure consisting of monitoring (toll) stations, monitoring (toll) subcenters and monitoring (toll) centers is proposed. At the road network management level, a hierarchical traffic operation coordination center (TOCC) or road network monitoring and management center has effectively realized the collection, transmission, processing and release of traffic flow, traffic accidents, construction maintenance and other information, which ensures the safe, reliable and efficient operation of the highway.

In recent years, on one hand, the scale of our country's highway network is expanding increasingly, the number of network nodes is increasingly, and the pressure on road network operation and management is becoming heavier increasingly; on the other hand, technologies such as autonomous driving, vehicle-road cooperation, and intelligent networked vehicles have developed rapidly. Implementations of these applications urgently require the perception, processing and release of highway information to be more accurate, timely and effective. The existing technical architecture and management system of highway electromechanical systems are facing major challenges, mainly as follows.

The first one is the challenge of system openness. The existing highway electromechanical system is a closed system based on a communication private network. It mainly collects information such as traffic flow and environment through roadside cameras, weather detectors, vehicle detectors and other outfield monitoring facilities. However, there is a lack of input channels of external information such as information of vehicles interacting through vehicle-road cooperation and status information of road users; at the same time, the internal charging, monitoring and emergency communication subsystems of the system are also independent and closed, and the openness of the system needs to be improved.

The second one is the challenge of accurate and timely information services. The basic data of the existing highway electromechanical system is basically reported level by level. Information calculation and processing are mainly deployed in the upper-level TOCC or monitoring center. The computing power of each level of TOCC is not fully utilized, and the information release mainly adopts a “from top to bottom” level-by-level release mode; at the same time, information services are mainly based on statistical reports, and timely information service capabilities for accurately positioning different road users and managers need to be improved urgently.

The third one is the challenge of intelligent decision-making and control. The core capabilities of the intelligent traffic system are reflected in the system's intelligent decision-making and control capabilities. In the existing highway electromechanical system, a large amount of traffic operation data is, accumulated; however, since the system technical architecture cannot adapt to the requirements of cloud computing platforms, artificial intelligence algorithms, etc., it cannot realize intelligent decision-making and autonomous control of the operation of the highway network, nor can it meet the information support demand for vehicle-road cooperative autonomous driving vehicles.

In the prior art, Document 1 (the document number is given later) aims to serve intelligent networked vehicles and alleviate the computational load on the vehicle side. It proposes a cloud control platform architecture in which the cloud includes a three-level platform including, a central cloud, regional clouds, and edge clouds, wherein the edge clouds are also based on the cloud computing technical architecture, and there is a flat direct, calling and sharing mode of data between the central cloud and the regional clouds. The cloud control platform architecture is only a technical architecture of a cloud platform, and it builds a cloud-end cooperative control system that includes two objects: a cloud platform and an intelligent networked vehicle. Document 2 (the document number is given later) aims to solve the problem of the central system's high computational load and low running speed. It proposes a data processing and control implementation method for an intelligent traffic cloud control system that includes a central system, a number of control servers, and a number of field devices. It adopts the traditional “from top to bottom” control instruction processing method, and does not emphasize and apply cloud computing architecture and cloud control technology.

It can be seen that an architecture model in which several cloud devices are arranged hierarchically from the end devices upward is generally proposed in the prior art. However, in the actual operation of traffic management, the cloud device architecture based on this hierarchical architecture has resulted in several problems, which are mainly reflected in the following aspects.

In a first aspect, there are obvious differences in the working mode and running state between low-level devices and high-level devices. For example, in addition to transmitting the originally collected data to the upper level, the lowest-level end device also needs to obtain control instructions from the upper level at high speed and with short latency (such as based on the data uploaded). In the prior art, due to the settings of multiple levels of cloud devices, long latency in response and transmission are caused. When a control instruction is obtained from the top-level cloud device (such as the central cloud or the regional clouds) and is sent to the end devices level by level, the high-speed and short-latency requirements often cannot be met.

In a second aspect, in the current cloud architecture, since cloud devices are arranged based on cloud computing architecture, data sharing management is generally adopted in the process of data transmission and processing. However, in the field of traffic management, since low-level devices are directly associated to devices directly related to traffic conditions, real-time traffic conditions, need to be collected and analyzed in a timely and fast manner so that instructions can be given. Therefore, the computing power of the devices is required to be more centralized. If the computing power is decentralized for data sharing between cloud devices, it often results in insufficient resources to cope with the demand for real-time data processing. However, if the data centralized storage and processing scheme is adopted between cloud devices, it will inevitably cause high deployment and maintenance costs of devices. The contradiction between the two needs to be overcome urgently.

In a third aspect, in the existing traffic control cloud architecture, focus is often only placed on the construction of a large control closed-loop from the top-level cloud device to the bottom-level end device, whereas the consideration of the high-efficiency transmission, fast processing, and short-latency response demands of the low-level devices different from those of the high-level devices from the perspective of “edge” is neglected. If the low-level devices are only generally included in the entire large control closed loop, their resources are usually occupied by the high-level devices (sometimes the low-level devices are not in the running state, but in a command-waiting state for the high-level devices), causing the low-level devices unable to fully perform the role of efficiently processing “edge”-level tasks. Based on this, the inventor of the present application further considers that if a small control closed loop on the “edge” side is constructed, it will easily cause a delay in the response to the control of the entire large control closed loop, and the contradiction between the two also urgently needs to be resolved.

Document 1: CN109688224A

Document 2: CN106251620B

In summary, there is an urgent need to propose a technical architecture solution of a traffic cloud control system, which is suitable for vehicle-road cooperative application scenes, which uses a cloud-edge-end cooperative mechanism, and which is data-driven.

### SUMMARY OF THE INVENTION

In order to solve the above problems, according to a first aspect of the present disclosure, a road traffic cloud control system is provided. The system has a traffic data processing and control instruction transmission architecture arranged hierarchically from bottom to top, including end devices, an edge subsystem and a cloud subsystem, the end devices including intelligent, on-board devices, traditional roadside devices and/or intelligent roadside devices, the intelligent on-board devices being configured to collect traffic vehicle data and/or receive traffic control instructions, and the traditional roadside devices and the intelligent roadside devices being configured to collect traffic status and traffic environment data and/or implement the issuance of traffic control instructions, wherein the cloud subsystem hierarchically includes road section clouds and upper-level clouds thereof from bottom to top, which are based on a cloud computing architecture; and

the edge subsystem includes: the road section clouds, and edge computing control devices based on a local computing architecture and arranged on the road side along the route of the road.

In this way, by configuring the edge subsystem under the cloud subsystem, and through a flexible configuration of edge computing devices based on the cloud computing architecture and edge computing devices based on the local computing architecture in the edge subsystem, at the same time of ensuring that the edge and the end can be effectively integrated into the cloud control hierarchical architecture, the present disclosure also ensures that the end devices can obtain control instructions based on edge decisions at high speed and with short latency.

Further, the road section clouds and the edge computing control devices form: an upper-and-lower hierarchical architecture, or an edge subsystem having an architecture with both upper-and-lower hierarchy and peer relationship.

Further, the upper-level clouds hierarchically include regional clouds and a road network cloud from bottom to top, and between the regional clouds and the road network cloud as well as between their respective peers, there are a direct calling and sharing architecture of the traffic data.

Further, there is no direct calling and sharing architecture of the traffic data between the road section clouds and the upper-level clouds.

Further, an edge side control closed loop is formed between the edge subsystem and the end devices.

Further, a cloud side control closed loop is formed between the cloud subsystem, the edge subsystem, and the end devices.

According to a second aspect of the present disclosure, a traffic control method is provided. which is applied to the traffic cloud control system described above, wherein the method includes:

receiving, by the edge subsystem, an edge computing request from the end device;

identifying a first attribute in the edge computing request;

determining that if the first attribute satisfies a first preset condition, the edge computing request is processed by the edge computing control device; and

determining that if the first attribute satisfies a second preset condition, the edge computing request is processed by the road section cloud;

wherein the first attribute includes a road section range of the end device from the edge subsystem, and/or a latency requirement of the edge computing request;

the first preset condition includes a narrow road section range and/or a short latency requirement; and

the second preset condition includes a wide road section range and/or a long latency requirement.

Further, the method further includes:

receiving the edge computing request by the edge computing control device and identifying the first attribute therein by the edge computing control device;

determining, by the edge computing control device, that the first attribute satisfies the second, preset condition;

forwarding, by the edge computing control device, the edge computing request to the road section cloud to process the edge computing request.

Further, the method includes:

when the road section cloud is running in the current edge side control closed loop, receiving a first control instruction from the upper-level cloud; and

exiting the road section cloud from the current edge side control closed loop based on the first control instruction.

Further, the exiting the road section cloud from the current edge side control closed loop based on the first control instruction includes:

the first control instruction including an exit instruction that instructs the road section cloud to exit from the current edge side control closed loop; and

exiting the road section cloud from the current edge side control closed loop based on the exit instruction.

Further, the exiting the road section cloud from the current edge side, control closed loop based on the first control instruction includes:

the first control instruction including a control execution instruction of the cloud side control closed loop;

performing a pre-deduction on the control execution instruction by the road section cloud; and

if it, is determined that, the result of the pre-deduction affects the running result of the current edge side control closed loop, exiting the road section cloud from the current edge side control closed loop.

Therefore, by configuring the edge subsystem under the cloud subsystem, and through a flexible configuration of edge computing devices based on the cloud computing architecture and edge computing devices based on the local computing architecture in the edge subsystem, at the same time of ensuring that the edge and the end can be effectively integrated into the cloud control hierarchical architecture, the present disclosure also ensures that the end devices can obtain control instructions based on edge decisions at high speed and with short latency. In addition, the contradiction between computing power being decentralized by the low-level devices for data sharing and the high cost and low efficiency of data centralized storage and processing scheme is effectively solved. Moreover, in the entire large control closed loop of the cloud side, it is further proposed to construct a small control closed loop of the end side, and at the same time, the problem of the small control closed loop of the edge side easily causing a delay in the response to the control of the entire large control closed loop of the cloud side is solved.

### BRIEF DESCRIPTION OF THE DRAWINGS

In order to more clearly describe embodiments of the present application or technical solutions in the prior art, the drawings that need to be used in the description of the embodiments or the prior art will be briefly introduced in the following. Obviously, the drawings in the following description are only illustrative. For those skilled in the art, other implementation drawings may also be derived from these provided drawings without creative work.

The text descriptions, connection relationships, etc. shown in this specification are only used for reading and understanding by people familiar with this art in cooperation with the contents disclosed in the specification. They are not intended to limit the defined conditions for implementation of the present application, so they do have not technically substantive significance. Any form of modification, any change to the connection relationships or any adjustment to the text descriptions, without affecting the effects and objects that can be achieved by the present application, should still fall within the scope that can be covered, by the technical content disclosed in the present application.

FIG. 1 is a schematic diagram of the architecture of a traffic cloud control system of the present disclosure;

FIG. 2 is a schematic flowchart of an embodiment of a traffic control method of the present disclosure;

FIG. 3 is a schematic diagram of the corresponding control relationship in another embodiment of the traffic control method of the present disclosure.

FIG. 4 is a schematic flowchart of another embodiment of the traffic control method of the present disclosure.

### DETAILED DESCRIPTION OF THE EMBODIMENT(S) OF THE INVENTION

In order to make the objects, technical solutions and advantages of the embodiments of the present application clearer, the technical solutions in the embodiments of the present application will be described below clearly and completely in conjunction with the drawings in the embodiments of the present application. Obviously, the described embodiments are only part of the embodiments of the present application, but not all of the embodiments. Based on the embodiments in the present application, all other embodiments obtained by those skilled in the art without creative work shall fall within the scope of protection of the present application.

The terms used in the embodiments of the present application are only for the purpose of describing specific embodiments, and are not intended to limit the present application. The singular forms “a”, “said” and “the” used in the embodiments of the present application are also intended to include plural forms, unless the context clearly indicates other meanings.

It should be understood that the term “and/or” used herein only indicates an association relationship describing associated objects, indicating that there may be three types of relationships. For example, A and/or B can mean the following three cases: A exists alone, or A and B exist at the same time, or B exists alone. In addition, the symbol “/” in this document generally indicates that the associated objects in front of and behind this symbol are in an “or” relationship.

Depending on the context, the words “if” and “in case of . . . ” as used herein can be interpreted as “when” or “at the time of . . . ” or “in response to the determination of . . . ” or “in response to the detection of . . . ”. Similarly, depending on the context, the phrase “if it is determined that . . . ” or “if the stated condition or event is detected” can be interpreted as “when it is determined that . . . ” or “in response to the determination of . . . ” or “when the stated condition or event is detected” or “in response to the detection of the stated condition or event.

It should also be noted that the terms “include”, “contain” or any other variation thereof are intended to cover non-exclusive inclusion, so that a commodity or system that includes a series of elements not only includes those elements, but also includes other elements that are not explicitly listed, or also include elements inherent to this commodity or system. If there are no more restrictions, the element defined by the sentence “including one . . . ” does not exclude the existence of other identical elements in the commodity or system that includes that element.

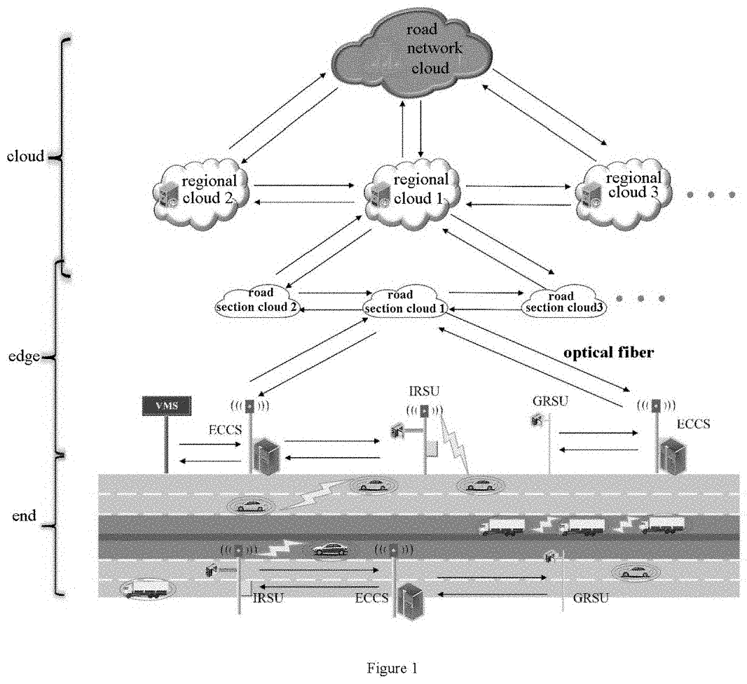

Reference is made to FIG. 1, which is a schematic diagram of the architecture of a traffic cloud control system of the present disclosure. The system has a traffic data and control instruction transmission architecture arranged hierarchically from bottom to top, including: end devices, an edge subsystem, and a cloud subsystem. It should be noted that the “traffic data” in the present disclosure includes both raw data (such as data collected by the end devices), intermediate data (such as intermediate results generated by the edge subsystem and the cloud subsystem from processing data collected by the end devices), and result data.

In addition, the cloud subsystem hierarchically includes road section clouds and upper-level clouds thereof from bottom to top, which are based on a cloud computing architecture. As a non-limiting example, the upper-level clouds herein may include regional clouds and a road network cloud from bottom to top as shown in FIG. 1.

The edge subsystem includes: the road section clouds, and edge computing control devices based on a local computing architecture and arranged on the road side along the route of the road (such as ECCSs in FIG. 1).

In this way, by configuring the edge subsystem under the cloud subsystem, and through a flexible configuration of edge computing devices based on the cloud computing architecture and edge computing devices based on the local computing architecture in the edge subsystem, at the same time of ensuring that the edge and the end can be effectively integrated into the cloud control hierarchical architecture, the present disclosure also ensures that the end devices can obtain control instructions based on edge decisions at high speed and with short latency.

Moreover, based on the cloud control system architecture, the present disclosure proposes a cloud-edge-end cooperative cloud control platform technology for road (such as highway) traffic. Regarding the various parts of the system architecture, a more detailed description will be given below in conjunction with FIG. 1:

(1) End (End Devices)

The end devices of the highway cloud control platform refer to terminal devices on the highway that have a stable and reliable network connection and can be online in real time. They mainly include the following two types:

One type is roadside terminal devices. They include video monitors, weather detectors, vehicle detectors, variable information boards and other general roadside devices/units (GRSU) (or referred to traditional roadside devices/units) deployed in the existing highway electromechanical system along the route, as well as intelligent roadside devices/units (IRSU) with I2X direct communication function, information collection function, local decision-making and control function deployed along the route during the intelligent construction or transformation of highways. The core function of IRSU is to use I2X direct communication for X2I information reception and I2X information release, and to use wireless or wired communication links to achieve information interaction with the road section clouds. IRSU is usually integrated with the functions of GRSU, such as a video monitor, thus having the function of information collection. IRSU is also usually equipped with a calculation processing unit, which generally uses microprocessors or microcontrollers such as single-chip microcomputers, FPGAs, etc., having local calculation functions with relatively simple and fixed algorithm.

The other type is vehicle-side intelligent terminal devices. They include not only intelligent networked vehicles with V2X direct communication function driving on the highway, but also intelligent terminal devices installed or carried inside the vehicle driving on the highway, such as on-board navigators and electronic toll collection on-board unit (ETC-OBU), intelligent phones, etc. From the perspective of providing information to the highway cloud control platform, the vehicle-side intelligent terminal devices have to provide dynamic data such as vehicle location and speed, as well as vehicle static data such as vehicle model and license plate number; from the perspective of receiving information provided by the highway cloud control platform, the vehicle-side intelligent terminal devices can receive information sent from IRSU, roadside edge computing control stations and clouds (the road section clouds, the regional clouds and the road network cloud).

(2) Edge (Edge Subsystem)

The edge of the highway cloud control platform refers to facilities with edge computing capabilities deployed along the route of the highway. They mainly include two types: roadside edge computing and control stations (Edge Computing & Control Station, ECCS) and road section cloud control centers (Cloud Control Center-Road Section, CCC-RS), wherein the road section cloud control centers may also be referred to as road section clouds (as shown in FIG. 1). ECCSs are deployed on the road side along the route of the highway, and the road section clouds are deployed according to actual functional requirements, and are generally deployed in computer rooms of road section management stations.

The edge and end on the road section form a small closed loop of edge monitoring and control (or referred to as edge side control closed loop). The core function of the edge is to perform real-time fused perception and edge insight calculations on the traffic flow, traffic incidents, traffic environment, and other data collected by the end on the road section, so as to realize the timely dynamic adjustment and precise control of the traffic conditions of this road section. The management and control implemented at the edge level is mainly intelligent autonomous control, supplemented by manual operation, so an algorithm library of mature and effective management and control strategies suitable for this road section is the core component of the edge.

Another important function of the edge is to store the massive basic information collected by the end on this road section and the massive intermediate data generated by its own edge calculation and control, analyze and process the massive information data purposefully, and upload the formed processing results to the regional clouds or the road network cloud. In addition, the edge needs to have a stable and reliable network connection, so that it can be connected downwardly to the end and online in real time, and can be connected upwardly to the regional clouds and the road network cloud through a private line with sufficient bandwidth.

It is worth noting that both ECCSs and road section clouds have edge computing capabilities, but have a clear functional division, so their configurations of performance are also different.

On one hand, ECCS is responsible for information processing and decision-making control of a specific range or scene where it is located, such as a 500-meter road section range (a narrow road section range), a confluence area, etc. It calculates and processes perception information involving traffic safety and short latency requirements (for example, within 100 milliseconds), and releases it timely. Therefore, it is necessary to have the I2X direct communication function, but does not adopt the technical architecture of the cloud computing center.

On the other hand, the road section cloud is responsible for information processing and decision-making control of a road section where it is located. The length of the road section can range from several kilometers to tens of kilometers (a wide road section range). It calculates and processes perception information involving traffic safety, travel services, and long latency requirements (for example, within 1 second) on this road section, and pushes it to the end device for release. The section clouds adopt the technical architecture of cloud computing. The adjacent section clouds constitute a private cloud, forming a dynamically expandable virtualized resource pool, including capabilities and services of computing, software, data access, storage, etc.

In this way, through the division of processing edge computing requests for different road section ranges and/or different latency requirements, it is possible to maximize the use of edge device resources and prevent a single device from being occupied by computing requests with different requirements, which would otherwise cause computing requests of corresponding requirements to be not effectively satisfied.

(3) Cloud (Cloud Subsystem)

The cloud of the highway cloud control platform refers to highway operational control centers based on the cloud computing technical architecture, i.e., the cloud control centers. According to the number of highway networks under management, different administrative divisions, or different operational management levels, the cloud control centers can be divided into three levels, namely, the road section cloud control centers (Cloud Control Center-Road Section, CCC-RS), the regional cloud control centers (Cloud Control Center-Roads Regional, CCC-RR), and the road network cloud control center (Cloud Control Center-Road Network, CCC-RN), which are referred to as road section clouds, regional clouds and road network cloud for short.

It can be seen that the road section clouds are included in the edge subsystem and the cloud subsystem at the same time. The physical computer rooms of the road section clouds are deployed alongside the road sections, and are used and managed by the road section management department. The technical features and functional architecture thereof are as described above. The regional clouds and the road network cloud can be built based on services such as infrastructure as a service (IaaS), platform as a service (PaaS) or software as a service (SaaS). The physical computer rooms thereof do not need to be locally in the region or the road network; rather, they are usually IDC computer rooms of professional cloud computing service companies, and are mainly responsible for the storage of massive data and the calculation and processing of complex tasks, as well as the processing of travel service information such as warnings and reminders. The latency is generally of the order of minutes.

The regional clouds and the road network cloud can adopt a more manual control method according to demand. Generally, there is a monitoring and command center with man on-duty. For example, for the highway cloud control platform of a province, the province's highway TOCC is responsible for using and managing the road network cloud, and the highway TOCC of each city is responsible for using and managing the regional clouds. However, from the perspective of computing and storage capabilities, due to the adoption of cloud computing technical architecture, the regional clouds and the road network cloud can only represent a logical division (rather than a division of physical hardware); users of the regional clouds and the road network cloud only have different scopes and authorities, of data access and processing, and different selected cloud services such as IasS, PaaS and SaaS. Data can be directly called between the regional clouds and the road network cloud, as well as between the road network cloud and the regional clouds. Technical barriers to data sharing under traditional architecture are avoided.

The cloud, edge and end of the entire cloud control platform form a closed loop of central monitoring and control (or referred to as cloud side control closed loop). The core function of the regional clouds and the road network cloud is to perform big data analysis on the massive data stored in a centralized manner to realize traffic optimization and control of regional road networks and the entire road network. On one hand, the road section clouds mainly perform edge insight calculations on data on this road section such as the traffic flow, traffic incidents, and traffic environment, so as to realize the timely dynamic adjustment and precise control of the traffic conditions of this road section; on the other hand, an edge side control closed loop is formed between the road section clouds and lower-level devices thereof (until the end devices), and the road section clouds play a role of communicating the upper and lower levels and closed-loop switching between the cloud side and the edge side control closed loops.

With the help of the powerful data processing and storage capabilities provided by the cloud computing technical architecture and the easy scalability of the resource pool, a direct calling and sharing architecture of traffic data can be constructed between the regional clouds and the road network clouds as well as between their respective peers, and a universal full-amount and full-time state detection system for the road network under management can be established to provide a data basis for road network-level traffic organization optimization and simulation evaluation of the implementation effect of management and control strategies. The full-amount includes road network traffic status, traffic incident status, and traffic environment status; and the full-time refers to every moment of 7×24 hours. Correspondingly, no direct calling and sharing architecture of traffic data is constructed between the road section clouds and the regional clouds, or between the road section clouds and the road network cloud, or between the road section cloud peers (such as the road section clouds 1, 2 and 3 in FIG. 1). In this way, the contradiction between computing power being decentralized by the low-level devices for data sharing and the high cost and low efficiency of data centralized storage and processing scheme can be effectively solved.

The road network cloud and the regional clouds should generate management and control strategies based on data-driven control theory, use fully shared universal full-amount and full-time traffic data, and use data uploaded by the road section clouds as system input to intelligently predict road network running state and control parameters, thus generating management and control strategies, automatically or manually controlling terminal devices, and realizing intelligent management and control of the operation of the highway network. The management and control strategies can be intelligently iterated based on data input from the system and feedback data output from the control, so as to improve the pertinence and implementation effect of the strategies.

It should be noted that the road section clouds and the edge computing control devices form: an upper-and-lower hierarchical architecture (as shown in FIG. 1, in which the ECCSs and the end devices communicate with each other, and the road section clouds and the ECCSs communicate with each other), or an architecture with both upper-and-lower hierarchy and peer relationship. More preferably, the road section clouds and the edge computing control devices form an architecture with both upper-and-lower hierarchy and peer relationship. Under this architecture, in addition to the inter-communication with the ECCSs, the road section clouds can also directly inter-communicate with the end devices.

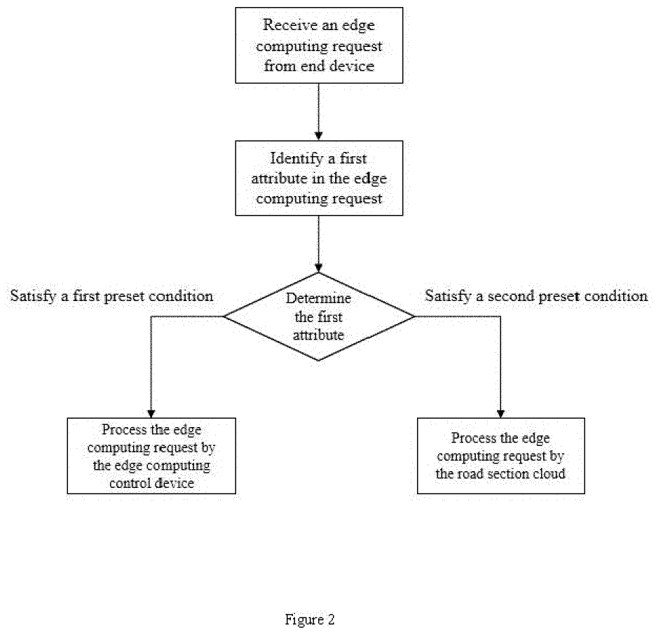

Referring to FIGS. 2-4, a second aspect of the present disclosure further provides a traffic control method, which is applied to the above cloud traffic control system.

Referring to FIG. 2, an embodiment of the traffic control method of the present disclosure may include:

receiving, by the edge subsystem, an edge computing request from the end device;

identifying a first attribute in the edge computing request;

determining that if the first attribute satisfies a first preset condition, the edge computing request is processed by the edge computing control device; and

determining that if the first attribute satisfies a second preset condition, the edge computing request is processed by the road section cloud;

wherein the first attribute includes a road section range of the end device from the edge subsystem, and/or a latency requirement of the edge computing request;

the first preset condition includes a narrow road section range (such as a 500-meter road section range) and/or a short latency requirement (such as within 100 milliseconds); and

the second preset condition includes a wide road section range (such as a length, of the road section ranging from several kilometers to tens of kilometers) and/or a long, latency requirement (such as within 1 second).

In this way, through the division of processing edge computing requests for different road section ranges and/or different latency requirements, the present disclosure can maximize the use of edge device resources and prevent a single device from being occupied by computing requests with different requirements, which would otherwise cause computing requests of corresponding requirements to be not effectively satisfied.

In this embodiment, further preferably:

the edge computing control device receives the edge computing request and identifies the first attribute therein;

the edge computing control device determines that the first attribute satisfies the second preset condition; and

the edge computing control device forwards the edge computing request to the, road section cloud to process the edge computing request.

In this way, the end device can be “focused” on the original data collection work it is responsible for, without having to allocate additional resources to decide whether to send the edge computing request to the road section cloud or the edge computing control device. The edge computing control device can uniformly collect the computing requests of the end devices, and forward the requests that satisfy the second preset condition to the road section clouds to avoid excessive occupation of its own resources.

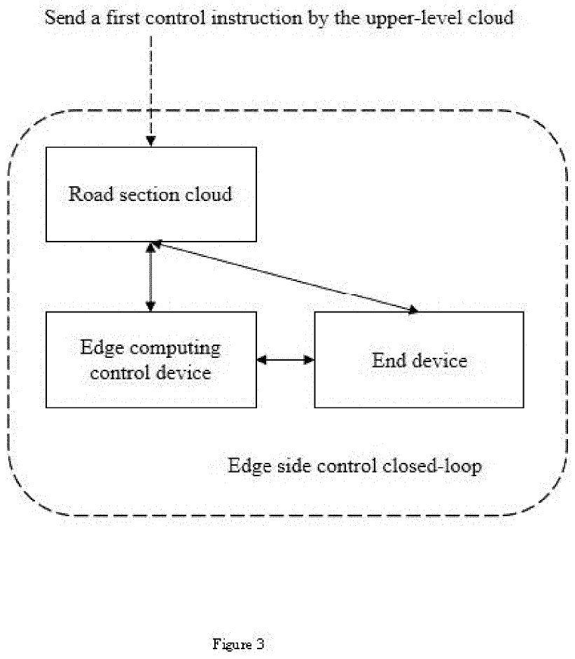

Referring to FIG. 3, another embodiment of the traffic control method of the present disclosure may include:

when the road section cloud is running in the current edge side control closed loop, receiving a first control instruction from the upper-level cloud; and

exiting the road section cloud from the current edge side control closed loop based on the first control instruction.

In this way, while the road section cloud is running in the current edge side control closed loop, it can also monitor the control instruction sent from the upper-level cloud, and exit from the current edge side control closed loop in time when the condition is satisfied, so as to prevent the small control closed loop of the edge side from causing a delay in the response to the control of the entire large control closed loop of the cloud side.

In this embodiment, preferably, the exiting the road section cloud from the current edge side control closed loop based on the first control instruction includes:

the first control instruction including an exit instruction that instructs the road section cloud to exit from the current edge side control closed loop; and

exiting the road section cloud from the current edge side control closed loop based on the exit instruction.

As a non-limiting example, the exit instruction may be that the upper-level cloud detects that the road section cloud is occupied by a small control closed-loop task, and the upper-level cloud has a higher-priority task in the large control closed-loop that needs to be processed immediately, so the issuance of the exit instruction can instruct the road section cloud to directly take the action of exiting from the edge side control closed loop.

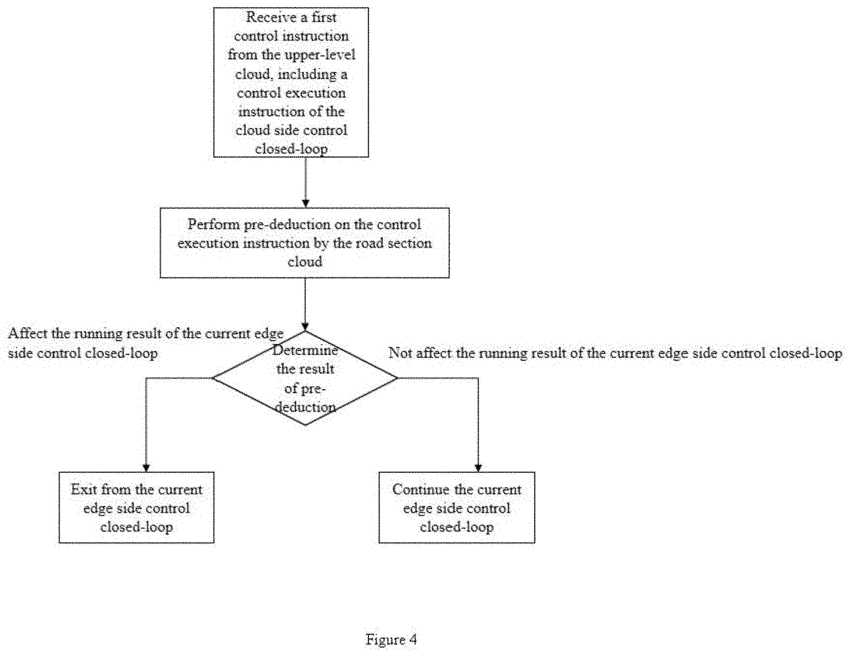

In this embodiment, preferably, referring to FIG. 4, the exiting the road section cloud from the current edge side control closed loop based on the first control instruction includes:

the first control instruction including a control execution instruction of the cloud side control closed loop;

performing a pre-deduction on the control execution instruction by the road section cloud; and

if it is determined that the result of the pre-deduction affects the running result of the current edge side control closed loop, exiting the road section cloud from the current edge side control closed loop.

As a non-limiting example, for example, a certain parameter A obtained from the pre-deduction result is a necessary parameter in the task executed by the current edge side control closed-loop, and the parameter A obtained from the pre-deduction result has changed relative to the parameter A used in the execution of the task. Then, it will inevitably have an impact on the running result of the current edge side control closed loop. Therefore, the road section cloud can exit from the current edge side control closed loop to avoid the invalid execution of the current task.

In summary, by making full use of technologies such as cloud computing, edge computing, big data, and artificial intelligence, the present disclosure proposes a technical architecture of a road (such as highway) traffic cloud-edge-end cooperative cloud control platform, which can overcome the defects of the technical architecture of existing road traffic operation management and monitoring systems. The highway cloud control platform designed and developed based on this technical architecture can improve the operational efficiency of the road network under the premise of ensuring safety, so that highway users can obtain more timely, effective, and personalized driving and traveling assistance information; moreover, practical applications such as vehicle-road cooperative autonomous driving and other functions are supported.

The above embodiments are only used to illustrate the technical solutions of the present application, but not to limit them; although the present application has been described in detail with reference to the foregoing embodiments, those skilled in the art should understand that they can still modify the technical solutions recorded in the foregoing various embodiments, or equivalently replace some or all of the technical features therein, and these modifications or replacements will not cause the essence of the corresponding technical solutions to deviate from the scope of the technical solutions of the embodiments of the present application.

What is claimed is:

1. A road traffic cloud control system, the system haying a traffic data processing and control instruction transmission architecture arranged hierarchically from bottom to top, and comprising: end devices, an edge subsystem, and a cloud subsystem, the end devices comprising intelligent on-board devices, traditional roadside devices and/or intelligent roadside devices, the intelligent on-board devices being configured to collect vehicle running data and/or receive traffic control instructions, and the traditional roadside devices and the intelligent roadside devices being configured to collect traffic status and traffic environment data and/or implement the issuance of traffic control instructions,
wherein the cloud subsystem hierarchically comprises road section clouds and upper-level clouds thereof from bottom to top, which are based on a cloud computing architecture; and the edge subsystem comprises: the road section clouds, and edge computing control devices based on a local computing architecture and arranged on the road side along the route of the road.

2. The road traffic cloud control system according to claim 1, wherein the road section clouds and the edge computing control devices form: an upper-and-lower hierarchical architecture, or an architecture with both upper-and-lower hierarchy and peer relationship.

3. The road traffic cloud control system according to claim 1, wherein the upper-level clouds hierarchically comprise regional clouds and a road network cloud from bottom to top, and between the regional clouds and the road network cloud as well as between their respective peers, there are a flat direct calling and sharing architecture of the traffic data.

4. The road traffic cloud control system according to claim 3, wherein there is no direct calling and sharing architecture of the traffic data between the road section clouds and the upper-level clouds.

5. The road traffic cloud control system according to claim 1, wherein an edge side control closed loop is formed between the edge subsystem and the end devices.

6. The road traffic cloud control system according to claim 2, wherein an edge side control closed loop is formed between the edge subsystem and the end devices.

7. The road traffic cloud control system according to claim 3, wherein an edge side control closed loop is formed between the edge subsystem and the end devices.

8. The road traffic cloud control system according to claim 4, wherein an edge side control closed loop is formed between the edge subsystem and the end devices.

9. The road traffic cloud control system according to claim 1, wherein a cloud side control closed loop is formed between the cloud subsystem, the edge subsystem, and the end devices.

10. The road traffic cloud control system according to claim 2, wherein a cloud side control closed loop is formed between the cloud subsystem, the edge subsystem, and the end devices.

11. The road traffic cloud control system according to claim 3, wherein a cloud side control closed loop is formed between the cloud subsystem, the edge subsystem, and the end devices.

12. The road traffic cloud control system according to claim 4, wherein a cloud side control closed loop is formed between the cloud subsystem, the edge subsystem, and the end devices.

13. The road traffic cloud control system according to claim 5, wherein a cloud side control closed loop is formed between the cloud subsystem, the edge subsystem, and the end devices.

14. A traffic control method, which is applied to the road traffic cloud control system according to claim 1, the method comprising:
receiving, by the edge subsystem, an edge computing request from the end device;
identifying a first attribute in the edge computing request;
determining that if the first attribute satisfies a first preset condition, the edge computing request is processed by the edge computing control device; and
determining that if the first attribute satisfies a second preset condition, the edge computing request is processed by the road section cloud;
wherein the first attribute comprises a road section range of the end device from the edge subsystem, and/or a latency requirement of the edge computing request;
the first preset condition comprises a narrow road section range and/or a short latency requirement; and
the second preset condition comprises a wide road section range and/or a long latency requirement.

15. The traffic control method according to claim 14, further comprising:
receiving the edge computing request by the edge computing control device and identifying the first attribute therein by the edge computing control device;
determining, by the edge computing control device, that the first attribute satisfies the second preset condition;
forwarding, by the edge computing control device, the edge computing request to the road section cloud to process the edge computing request.

16. The traffic control method according to claim 14, which is applied to the road traffic cloud control system according to claim 5, wherein the method comprises:
when the road section cloud is running in the current edge side control closed loop, receiving a first control instruction from the upper-level cloud; and
exiting the road section cloud from the current edge side control closed loop based on the first control instruction.

17. The traffic control method according to claim 14, which is applied to the road traffic cloud control system according to claim 9, wherein the method comprises:
when the road section cloud is running in the current edge side control closed loop, receiving a first control instruction from the upper-level cloud; and
exiting the road section cloud from the current edge side control closed loop based on the first control instruction.

18. The traffic control method according to claim 15, which is applied to the road traffic cloud control system according to claim 5, wherein the method comprises:
when the road section cloud is running in the current edge side control closed loop, receiving a first control instruction from the upper-level cloud; and
exiting the road section cloud from the current edge side control closed loop based on the first control instruction.

19. The traffic control method according to claim 15, which is applied to the road traffic cloud control system according to claim 9, wherein the method comprises:
when the road section cloud is running in the current edge side control closed loop, receiving a first control instruction from the upper-level cloud; and
exiting the road section cloud from the current edge side control closed loop based on the first control instruction.

20. The traffic control method according to claim 16, wherein the exiting the road section cloud from the current edge side control closed loop based on the first control instruction comprises:
the first control instruction comprising an exit instruction that instructs the road section cloud to exit from the current edge side control closed loop; and
exiting the road section cloud from the current edge side control closed loop based on the exit instruction.

21. The traffic control method according to claim 16, wherein the exiting the road section cloud from the current edge side control closed loop based on the first control instruction comprises:
the first control instruction comprising a control execution instruction of the cloud side control closed loop;
performing a pre-deduction on the control execution instruction by the road section cloud; and
if it is determined that the result of the pre-deduction affects the running result of the current edge side control closed loop, exiting the road section cloud from the current edge side control closed loop.
